(19) United States
(12) Patent Application Publication
(10) Pub. No.: US 2006/0099963 A1
(43) Pub. Date: May 11, 2006

(54) Location-based mobile service provision

(75) Inventor: Paul Stephens, Berkshire (GB)

Correspondence Address: MOTOROLA INC, 600 NORTH US HIGHWAY 45, ROOM AS437, LIBERTYVILLE, IL, 60048-5343, US

(73) Assignee: Motorola, Inc.

(21) Appl. No.: 10/539,849

(22) PCT Filed: Dec. 5, 2003
(86) PCT No.: PCT/EP03/50951

§ 371 Date: Jun. 20, 2005

(30) Foreign Application Priority Data
Dec. 20, 2002 (GB) 0229921.2

(51) Int. Cl. H04Q 7/20

(52) U.S. Cl. 455/456.3

(57) ABSTRACT

A method (300) of providing location based services using a wireless communication system (100, 200) that facilitates communication to and/or from a plurality of communication units (250-262). The method includes the step of transmitting a wireless message (220), from a mobile service provider (112) to a number of communication devices in a location (210). The wireless message indicates a service to be provided by the mobile service provider (112) at the location (210). This enables mobile service providers to enhance their business via their mobile communication device, i.e. advertise their services to a geographically near, group of users. Preferably the recipient group of users have previously subscribed to, or registered their interest in, the services provided by the mobile service provider.

### FIELD OF THE INVENTION

This invention relates to location based mobile service provision in existing or future wireless, or integrated wireless and fixed, communication systems.

### BACKGROUND OF THE INVENTION

Wireless communication systems, for example cellular telephony or private mobile radio communication systems, typically provide for radio telecommunication links to be arranged between a plurality of base transceiver stations (BTSs) and a plurality of subscriber units, often termed mobile stations (MSs).

The communication link from a BTS to a MS is generally referred to as a down-link communication channel. Conversely, the communication link from a MS to a BTS is generally referred to as an up-link communication channel.

In a wireless communication system, each BTS has associated with it a particular geographical coverage area (or cell). The coverage area is defined by a particular range where the BTS can maintain acceptable communications with MSs operating within its serving cell. Often these cells combine to produce an extensive coverage area.

Wireless communication systems are distinguished over fixed communication systems, such as the public switched telephone network (PSTN), principally in that mobile stations move between coverage areas served by different BTS (and/or different service providers) and, in doing so, encounter varying radio propagation environments.

Recently, in the areas of cellular mobile communication systems, there has been a significant interest in third generation (3G) location based service provision. The proposals within the 3G communicaitons standards environment have focused on providing a variety of services to a roaming MS in a particular geographical area or communication cell. In particular, when a MS enters an area or cell, the MS receives services and information targeted at individual MS within that geographic area or cell. This is a valuable and desirable concept to MS users, so that they can be provided with all of the information they want or need, whenever and wherever they want or need the information.

Location Based Services today, are focused on filtering a database of information for the specific needs of MS users in a specific Cell. They are all based on the premise that the service is static.

An important feature of many applications, which operators and vendors are actively exploring, is location based service delivery. These services can include location-specific information such as listing restaurants in the area of the serving cell and community services.

In the field of this invention, International Patent Application WO 02/49386 A1 by Ericsson™, titled “Method and Apparatus for Location Based Services in a Cellular Communications System” describes one mechanism for location-based service provision. In this document, an interactive response node communicates between a user, a location retrieval function and a mobile switching centre (MSC) to control the location-based services that are delivered to the user by the MSC. In this manner, a location of the MS is determined, and services specific to the MS are provided to the roaming user based on its location.

The inventor of the present invention has recognised that all of the known location-based services are focused on the provision of services to the roaming mobile communication unit. In this regard, the inventor has appreciated that significant and numerous opportunities exist by viewing location-based services in an alternative manner.

Thus, in the field of the present invention, an opportunity has been recognised and appreciated to provide an enhanced provision of location-based services wherein the abovementioned limitations are alleviated.

### STATEMENT OF INVENTION

In accordance with a first aspect of the present invention, there is provided a method of providing location based services, as claimed in Claim 1.

In accordance with a second aspect of the present invention, there is provided a storage medium storing processor-implementable instructions, as claimed in Claim 18.

In accordance with a third aspect of the present invention, there is provided a communication system, as claimed in Claim 19.

In accordance with a fourth aspect of the present invention, there is provided a mobile service provider, as claimed in Claim 21.

In accordance with a fifth aspect of the present invention, there is provided a server, as claimed in Claim 23.

In accordance with a sixth aspect of the present invention, there is provided a communication unit, as claimed in Claim 24.

In accordance with a seventh aspect of the present invention, there is provided a Mobile Services Manager function, as claimed in Claim 28.

Further aspects of the present invention are as claimed in the dependent claims.

In summary, in accordance with the preferred embodiment of the present invention, the inventive concepts described herein reverse the current methodology on location-based service provision. In this regard, a communications opportunity for a Service provider that is mobile is described. In contrast to known location-based services, which assume that when a mobile communication unit moves into an area it is able to receive services applicable to that mobile communication unit in that area, the present invention starts from the premise that the mobile communication unit, or particularly its user, provides the service in that location.

### BRIEF DESCRIPTION OF THE DRAWINGS

Exemplary embodiments of the present invention will now be described, with reference to the accompanying drawings, in which:

FIG. 1 shows a block diagram of a communication system that can be adapted to support the various inventive concepts of a preferred embodiment of the present invention;

FIG. 2 shows a functional block diagram of location-based service provision and advertising in accordance with various inventive concepts of a preferred embodiment of the present invention;

FIG. 3 is a flowchart illustrating a mobile service provision mechanism in accordance with various inventive concepts of a preferred embodiment of the present invention; and

FIG. 4 shows a block diagram of a wireless communication unit adapted as a mobile service provider in accordance with the preferred embodiment of the present invention.

### DESCRIPTION OF PREFERRED EMBODIMENTS

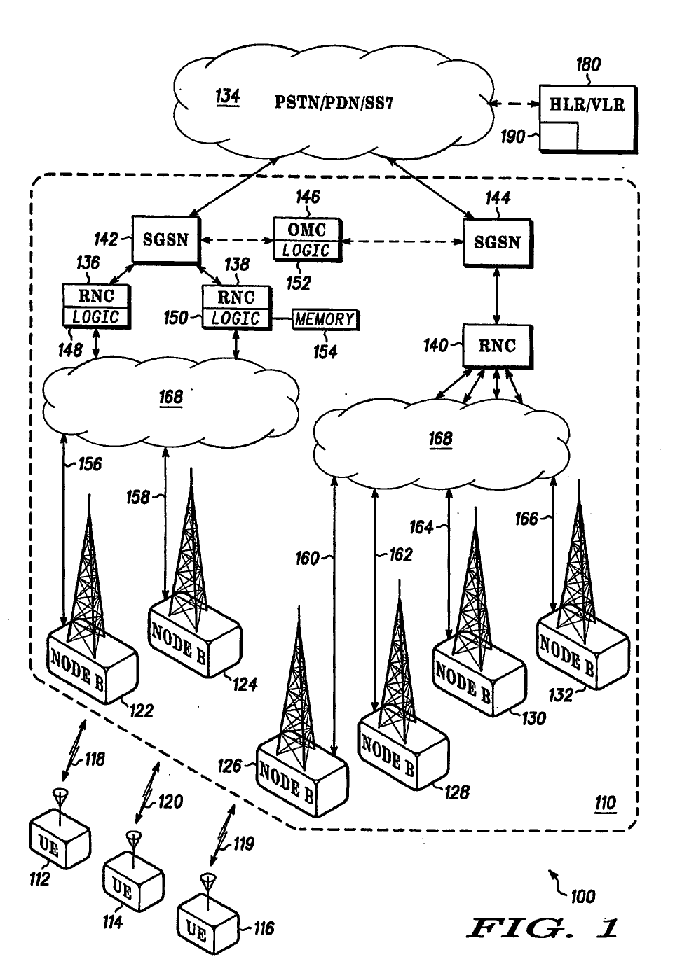

Referring first to FIG. 1, a cellular-based telephone communication system 100 is shown in outline, in accordance with a preferred embodiment of the invention. In the preferred embodiment of the invention, the cellular-based telephone communication system 100 is compliant with, and contains network elements capable of operating over, a universal mobile telecommunication system (UMTS) and/or a general packet radio system (GPRS) air-interface.

In particular, the invention relates to the Third Generation Partnership Project (3GPP) specification for wide-band code-division multiple access (WCDMA) standard relating to the UTRAN radio Interface (described in the 3G TS 25.xxx series of specifications developed by the European Telecommunications Standards Institute (ETSI)).

A plurality of subscriber terminals (or user equipment (UE) in UMTS nomenclature) 112, 114, 116 communicate over radio links 118, 119, 120 with a plurality of base transceiver stations, referred to under UMTS terminology as Node-Bs, 122, 124, 126, 128, 130, 132. The system comprises many other UEs and Node Bs, which for clarity purposes are not shown.

The wireless communication system, sometimes referred to as a Network Operator's Network Domain 110, is connected to an external network 134, for example the Internet. The Network Operator's Network Domain (described with reference to both a 3^{rd} generation UMTS and a 2^{nd} generation GSM system) includes:
(i) A core network, namely at least one Gateway GPRS Support Node (GGSN) 144 and/or at least one Serving GPRS Support Nodes (SGSN); and
(ii) An access network, namely:
   (ai) a GPRS (or UMTS) Radio network controller (RNC) 136-140; or
   (aii) Base Site Controller (BSC) in a GSM system and/or
   (bi) a GPRS (or UMTS) Node B 122-132; or
   (bii) a Base Transceiver Station (BTS) in a GSM system.

The GGSN/SGSN 144 is responsible for GPRS (or UMTS) interfacing with a Public Switched Data Network (PSDN) such as the Internet 134 or a Public Switched Telephone Network (PSTN) 134. A SGSN 144 performs a routing and tunnelling function for traffic within say, a GPRS core network, whilst a GGSN 144 links to external packet networks, in this case ones accessing the GPRS mode of the system

The Node-Bs 122-132 are connected to external networks, through base station controllers, referred to under UMTS terminology as Radio Network Controller stations (RNC), including the RNCs 136, 138, 140 and mobile switching centres (MSCs), such as MSC 142 (the others are, for clarity purposes, not shown) and SGSN 144 (the others are, for clarity purposes, not shown).

Each Node-B 122-132 contains one or more transceiver units and communicates with the rest of the cell-based system infrastructure via an I_{ub} interface, as defined in the UMTS specification.

Each RNC 136-140 may control one or more Node-Bs 122-132. Each MSC 142 provides a gateway to the external network 134. The Operations and Management Centre (OMC) 146 is operably connected to RNCs 136-140 and Node-Bs 122-132 (shown only with respect to Node-B 126 for clarity). The OMC 146 administers and manages sections of the cellular telephone communication system 100, as is understood by those skilled in the art.

A location registry function 180, comprising home location register and visitor location register details is shown at a high level in the system architecture, so that the location information is system-wide. A skilled artisan would appreciate that the location registry function 180 may, in alternative embodiment, be operably coupled to lower level elements such as the SGSN 142, 144, a GGSN not shown or the OMC-146.

In the preferred embodiment of the invention, one or more roaming UEs 112-116 have been adapted/re-configured as a service provider instead of as a service recipient. In this regard, the roaming UE is able to offer, and provide, services to other users, for example other users within a particular geographical area who have expressed an interest in the services offered.

In a passive mode of operation, the UE of the Service Provider, say UE 112, is configured to monitor its location. UE 112 then updates a mobile services manager 190, preferably located within the location registry function 180, with updated location information at regular intervals, or when a change in location has been determined. In an alternative implementation, the Service Provider's UE has been adapted to store limited details of subcribers. Furthermore, in such an implementation, it is envisaged that the UE is able to directly control forwarding of notifications, when the UE determines that it is in the default location area for those subscribers. Further improvements to the UE are described with reference to FIG. 4.

In the preferred embodiment of the present invention a new function, a Mobile Services Manager function 190, is introduced to act as a repository for the sevice profile information provided by the Mobile Service Provider. Although the Mobile Services Manager function 190 is shown as part of the location registry function 180. it is within the contemplation of the invention that the Mobile Services Manager function 190 may be located elsewhere within the system, for example operably coupled to cell or site specific devices, where the service to be provided is specific to a particular area.

It is envisaged that the Service Provider (UE user) is able to activate or deactivate his/her service in the Mobile Services Manager function 190. When activated, the Service Provider is able to set the notification profile, which determines when subscribers are notified of the Service Provider's proximity or arrival. In the preferred embodiment of the present invention, the Service Provider is provided with the ability to effect such changes through WEB or WAP pages. The Mobile Services Manager 190 also stores the subscriptions of the service users that subcribe to the service, as described later.

An example of such a service is a tradesman visiting a particular geographical area. Whilst performing a service in the area, it is cost effective to such a service provider to perform further services or make other calls in the same area even, for example, advertising or cold-calling calls. In accordance with the preferred embodiment of the present invention, the mobile service provider's UE is configured to advertise the mobile Tradesman's service prior to, or whilst visiting, the communication cell or the local geographic area. Other users in the same communication cell or geographic area are advantageously informed of the availability of the service whilst the mobile service provider is active in the area.

Another advantageous example of applying the inventive concepts herein described is in the case of a mobile canteen/food wagon visiting an industrial estate. When the mobile canteen service is planning to visit particular communication cell, the mobile service provider preferably informs a server supporting the cell, for example a server integral within, or operably coupled to, the serving Node-B. The server then transmits details of the service offered, i.e. the menu, to users (preferably subscribed users). Subsequently, the users are notified when the mobile service provider has reached their location.

A further envisaged example is conference calling. By enabling a mobile communication unit as a mobile service provider, i.e. one that provides conference calling, a presenter at a conference can hold an interactive debate and share data directly in a manner similar to Net-meeting™.

From a subcription perspective, the mobile service could be made globally available, only to become active when the Provider is in the same Cell or location as the service subcribers. Alternatively, subscription may not become visible until the Provider is actually in the same Cell as the prospective recipients. In the case of the conference presenter, the interactive conference service may be made available to everyone in the In-Building Cell. It is then envisaged that this service could include a feed of the conference audio, a feed of translated audio, interactive voting opportunities and a reverse audio capability (i.e. the ability to use one's phone to address the conference).

A yet further example of the application of the aforementioned inventive concepts is in the application to community transport timetables, for example relating to trains or buses. In this context, people who are waiting for buses or trains are provided with the opportunity to dynamically check the likely arrival time of the service at their location.

Clearly, a skilled artisan would appreciate the vast array of applications and opportunities that are made available to users through the inventive concepts described herein. In this regard, the examples provided above highlight only a snapshot of these.

In principle, in the preferred embodiment of the present invention, the mobile service provider's UE sends data to update a remote web server with information relevant to the service that is being provided. The communication to/from the web server is performed via the PSTN/PDN/SS7 external network 134. In accordance with the preferred embodiment, a number of communication unit users who are interested in the service preferably subscribe to the service. It is envisaged that the network operator may obtain significant revenues from a large number of subscriptions relating to a variety of services. Such subscribers may be users of other UEs that are operational in the same geographical area as the UE service provider.

A list of service subscribers, for the various services supported, is maintained preferably in a memory element or database operably coupled to, or integral with, any appropriate network element. In this manner, the respective network element has to ensure notification of specific service events or the availability of the service at the respective location identified by the roaming service provider. The assumption is that the service provider information is updated dynamically according to the location of the roaming mobile service provider.

It is envisaged that such notification of specific events, or the availability of the service at the respective location, could be activated on at least two levels:
(i) When the Service provider is in, or has indicated a subsequent visit to, the cell area. In this manner, the notification could be performed using a cell broadcast; and/or
(ii) When the Service provider moves into, or approaches, a particular post code, the notification could be provided to the user via a short message service (SMS) message. In this regard, it is envisaged that the user would have provided their post code to, say, the web server, when subscribing to the service. Alternatively, the location of the mobile service provider is continuously updated with the geographic location, preferably translated to a postcode, to assist with a postcode-based trigger of the SMS.

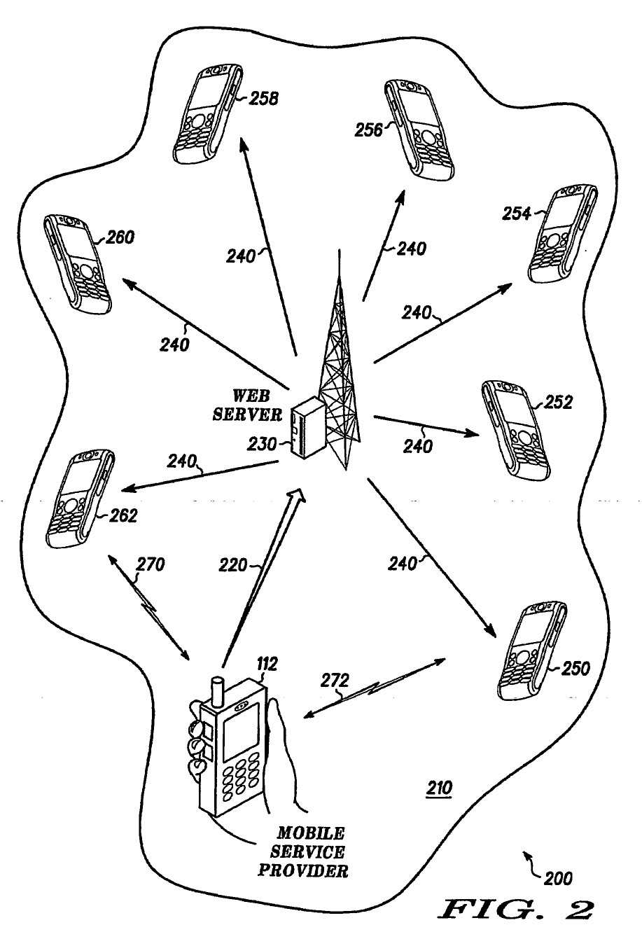

Referring now to FIG. 2, a functional block diagram 200 of location-based service provision and advertising is shown, in accordance with various inventive concepts of a preferred embodiment of the present invention. For example, the service provision message from the service provider is ultimately delivered to a plurality of user equipment (UE). The plurality of user equipment have preferably previously registered an interest in, and/or subscribed to, the service offered by the mobile service provider 112.

In accordance with the preferred embodiment of the present invention, a user of a UE, for example UE-1 112, wishes to advertise his/her services as a mobile service provider. In this regard, the mobile service provider 112 transmits a mobile service provision message 220 to an intermediate device, preferably to a web-server 230 or Node-B or base transceiver station. Such a transmission occurs on an uplink channel.

The web-server 230 receives the mobile service provision message 220, and accesses a database (not shown) to identify a group of UE users 250-262 that have registered an interest in, and/or subscribed to, such a service. Preferably, the group of UE users are geographically near to the mobile service provider 112, for example located within the same cell 210 as shown in FIG. 2. The web-server then broadcasts 240 a message identifying the availability of the mobile service provider 112 within that cell 210 or geographical area.

By combining WEB and Cell Broadcast services, the mobile service provider can continuously update a web server. The WEB server, in turn, provides updated service information to those subscribed UEs in respective cells/local geographical area who have previously subscribed to the service. In this manner, when a subscriber's current location is included in the database information, the subscriber is alerted directly when the mobile service provider enters their geographic or postcode area.

It is envisaged that the broadcast message may be a downlink message communicated in the same wireless communication system. For example, the server may be a message serving unit or function contained within one or mode Node Bs, i.e. one or more Node Bs 122-132 of FIG. 1 transmitting a broadcast message on a downlink channel corresponding to the uplink channel used by the mobile service provider.

In an alternative embodiment, it is envisaged that the broadcast message may use a fixed communication system for broadcasting the availability of the mobile service provider 112, for example by sending email notifications to subscribers registered within a particular geographical area or post code.

In a further alternative embodiment, it is envisaged that the mobile service provider 112 may transmit a service provision advertisement message directly to subscriber UE's that have previously registered an interest in the service offered by the mobile service provider. In this regard, it is envisaged that the mobile service provider 112 may have ‘downloaded’ a list of service subscribers prior to travelling to the geographic area 210. In this manner, the UE of the mobile service provider 112 may be configured to transmit automatically a “mobile service availability” message 270, 272 to UEs identified from the list, as soon as the mobile service provider 112 moves into that location.

In a yet further embodiment of the present invention, it is envisaged that a discovery (polling) and coordination protocol may be utilised, for example on a short-range adjunct (Bluetooth™) channel. In this regard, the mobile service provider, after moving into the area, is able to poll other UE devices in the same geographic area (or cell). In this manner, the mobile service provider determines whether any of the UE devices have registered an interest within, say, their UE profiles to use the services provided by the mobile service provider 112. If a number of UE devices indicate that they have registered such an interest, the mobile service provider 112 may then co-ordinate the responses to determine whether it is worth broadcasting a service availability message, either to a local server or individually to the respective UE devices. Such a broadcast, or number of indivdual transmissions, may take place during the mobile service provider's periods of inactivity on its primary-communciation UMTS system.

It is envisaged that such broadcast messages may be sent (either from a server or the mobile service provider) on an intermittent basis, or periodically, or during low traffic periods to utilise less expensive calling rates. Once the mobile service provider 112 has broadcast the service availability message, each of the receiving UEs 250-262 preferably log the fact that a particular mobile service provider has entered the area. Should the user of any of the UEs 250-262 subsequently desire the service provided by the mobile service provider 112, they are able to search their individual UE databases for the contact details of the mobile service provider, and contact the provider directly.

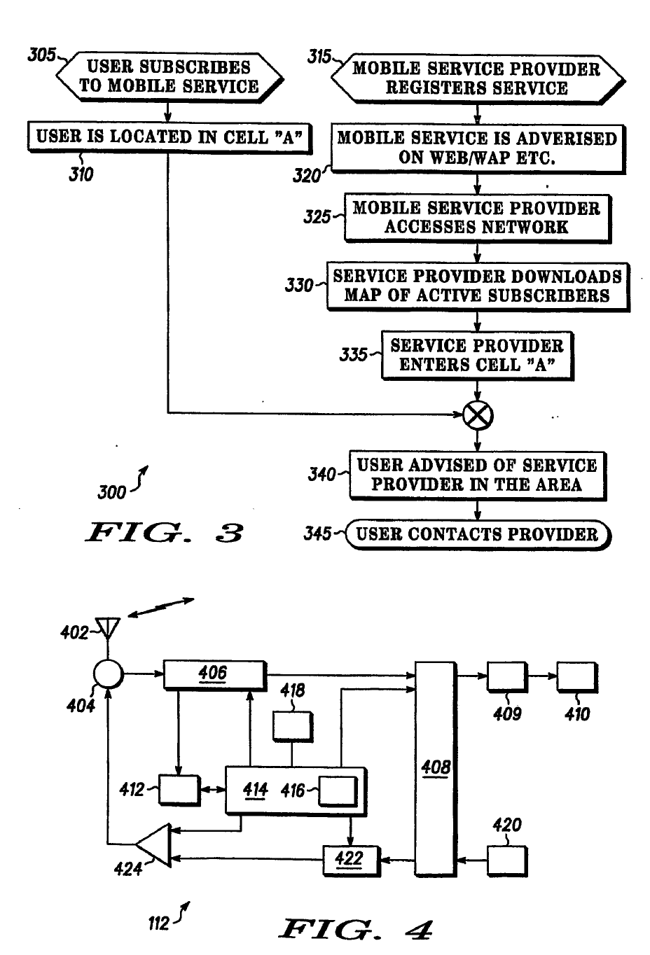

Referring now to FIG. 3, a flowchart 300 of a preferred operation of the mobile service provider is illustrated. Preferably, the mechanism operates using a list of users, for example mobile users having UE, that have previously subscribed to/registered an interest in a particular service, as shown in step 305. The preferred embodiment of the present invention operates on a location-based premise; for example, when the subscribed mobile is located within a particular area or cell, as in step 310.

A mobile service provider preferably registers their services with the network, as shown in step 315. In this manner, the network is able to perform checks on the service provider to authenticate that the mobile service provider is qualified to offer the identified service to its users. Once registered, the network provider may advertise the service as being one supported by the network, for example by advertising the service on a World Wide Web page and/or a wireless access protocol (WAP) page, as shown in step 320.

In one embodiment of the present invention, the mobile service provider may access the network in step 325 and download details of the currently active subscribers, as shown in step 330. The mobile service provider is then able to determine whether the geographical area/cell has the potential to fulfil his/her business interests. If it does, the mobile service provider may enter the geographic area/cell in step 335. Once located within the geographic area/cell, the subscribed UEs are informed that the service provider is in the area, in step 340. If the user of the subscribed UE wishes to utilise the service offered, the user preferably contacts the mobile service provider in step 345. It is envisaged that the contact details are preferably sent with the notification of the mobile service provider's availability.

A skilled artisan would appreciate that a number of the aforementioned steps are optional and/or could be performed in a different order. A few examples of re-ordering of steps include:
(i) The mobile service provider may access the network and download maps of active subscribers after registration, perhaps before the mobile service providers service has been advertised via a broadcast message.
(ii) If a discovery and coordination embodiment was followed, there is no requirement for the users to subscribe to the mobile service, and a polling exercise could be followed.

For multi-mode communication units, for example applicable to 3G systems, it is envisaged that such service provision could be dedicated to one mode of operation. For example, if the UEs operating in a given cell are capable of both UMTS and bluetooth operation, it is envisaged that the service provider broadcasts could be sent out on one or more Bluetooth™ channels. It is envisaged that a protocol would preferably be developed to support the broadcast of mobile service providers using the short-range Bluetooth communication system, preferably configured as an adjunct channel. Alternatively, for example, if the UE is capable of UMTS and GSM operation, the service provision broadcast could be sent out as a short data message service (SMS) transmission on the GSM channels, whilst the higher rate UMTS channels are used for primary traffic communications.

Referring now to FIG. 4, a block diagram of a mobile service provider's communication unit is illustrated, for example a user equipment (UE) 112 of FIG. 1. The UE 112 is adapted to support the inventive concepts of the present invention.

As known in the art, the UE 112 contains an antenna 402 preferably coupled to a duplex filter or antenna switch 404 that provides isolation between receive and transmit chains within UE 112.

The receiver chain includes scanning receiver front-end circuitry 406 (effectively providing reception, filtering and intermediate or baseband frequency conversion). The scanning front-end circuit 406 scans for signal transmissions from its associated Node B, for example enquiries from subscribers of the mobile service provider's service. The scanning front-end circuit 406 is serially coupled to a signal processing function (processor, generally realised by a DSP) 408. The final receiver circuits are a baseband back-end circuit 409 operably coupled to a display unit 410.

In accordance with the registration aspect of the present invention, the receiver chain 410, in particular the signal processing function 408, coupled to the baseband back-end circuit 409, receives a notification from a network operator, web server, or similar network/communciation provider that a request to regisiter the mobile service provider's services has been accepted.

For completeness, a controller 414 is preferably operably coupled to the scanning front-end circuitry 406 so that the receiver can calculate receive bit-error-rate (BER) or frame-error-rate (FER) or similar link-quality measurement data from recovered information via a received signal strength indication (RSSI) 412 function. The RSSI 412 function is operably coupled to the scanning front-end circuit 406. In this manner the mobile service provider's UE operates as a standard UE device, as well as supporting the service provision mechanism herein described.

The memory device 416 stores a wide array of UE-specific data, such as decoding/encoding functions, timing details, neighbour and serving cell information relating to timing, channels, power control and the like. In addition, the memory unit 416 has now been adapted to store a list of subscribers that have registered an interest in the service offered by the mobile service provider in a particular area/cell.

A timer 418 is operably coupled to the controller 414 to control the timing of operations, namely the transmission or reception of time-dependent signals, within the UE 112. For completeness, in broad terms, the transmit chain of the UE 112 essentially includes an input device 420, such as a microphone, coupled in series through a processor 408, transmitter/modulation circuitry 422 and a power amplifier 424. The processor 408, transmitter/modulation circuitry 422 and the power amplifier 424 are operationally responsive to the controller, with an output from the power amplifier coupled to the duplex filter or antenna switch 404, as known in the art.

The signal processing function 408, controller 414 and memory device 416 have been adapted to effect an uplink transmission of the mobile service provider's contact details, service provided/offered, geographical location, etc. to a web-server or other broadcast element.

The signal processor function 408 in the transmit chain may be implemented as distinct from the processor in the receive chain. Alternatively, a single processor 408 may be used to implement processing of both transmit and receive signals, as shown in FIG. 4.

Of course, the various components within the mobile service provider's communication unit 112 can be realised in discrete or integrated component form, with an ultimate structure therefore being merely an arbitrary selection.

More generally, adaptation of UE 112 to support the aforementioned the mobile service provider messages in the preferred embodiment of the present invention may be implemented in a respective communication unit (UE) in any suitable manner. For example, new apparatus may be added to a conventional communication unit (for example UE 112), or alternatively existing parts of a conventional communication unit may be adapted, for example by reprogramming one or more processors therein. As such the required adaptation may be implemented in the form of processor-implementable instructions stored on a storage medium, such as a floppy disk, hard disk, PROM, RAM or any combination of these or other storage multimedia.

Although the preferred embodiment of the invention is described with reference to a wireless communication device such as a mobile phone employing a UMTS air-interface, it is envisaged that the aforementioned wireless communication device in the preferred embodiment of the present invention may, in alternative embodiments, be any one of: a cellular phone, a portable or mobile radio, a personal digital assistant, a laptop computer or a wirelessly networked PC.

Furthermore, it is within the contemplation of the invention that the inventive concepts described herein can be applied to any fixed or wireless communication system, and are thus not limited to third Generation Cellular data networks. For example, it is envisaged that the location-based mobile service provider mechanism may be capable of operation with the global system for mobile communications (GSM) or the general packet radio system (GPRS) or the integrated Digitally Enhanced Network (iDEN™) provided by Motorola™.

In particular, it is within the contemplation of the invention that such communications may also utilise an adjunct communication channel, for example, a bluetooth short-range radio connection. It is also envisaged that any network server may be configured to support the coordination of mobile service provider information and messages, with a web-based server described as a preferred option.

It will be understood that the mechanism for location-based services to be initiated via an uplink transmission from a mobile communication unit, as described above, provides at least the following advantages:
(i) An opportunity for service providers to enhance their business via their mobile communication device, i.e. advertise their services to a geographically near, group of users. Preferably the recipient group of users have previously identified themselves as interested in the services provided by the mobile service provider.
(ii) Expand the concept of Location Based Services to conference facility use as described previously.
(iii) Expand the concept of Location Based Services at major events, such as major sporting events, where many of the available services are not fixed to a specific venue, but are mobile and provide everything from catering to entertainment at many different venues.

Whilst the specific, and preferred implementations of the embodiments of the present ivention are described above, it is clear that variations and modifications of such invnetive concepts could be readily applied by one skilled in the art.

Thus, a method of providing location based services and a mobile service provider have been provided where the limitations associated with prior art location-based approaches have been substantially alleviated.

1-31. (canceled)

32. A method of providing location based services by a mobile service provider using a wireless communication system that facilitates communication with a plurality of communication units, the method comprising:
providing location information, via a mobile communication unit adapted for use by the mobile service provider of at least one of a current location of, and a location to be visited by, the mobile service provider to an intermediate device; and
initiating the transmission of a wireless message, by the intermediate device in dependence on the location information provided by the mobile service provider, to a number of communication devices in the at least one of the current location of, and the location to be visited by, the mobile service provider, wherein said wireless message indicates a service to be provided by said mobile service provider at the at least one of the current location of, and the location to be visited by, the mobile service provider.

33. The method according to claim 32, wherein the initiating the transmission of a wireless message step comprises transmitting a wireless message to a number of communication devices in a predetermined location when the location information indicates the mobile service provider has at least one of moved into and is approaching the predetermined location.

34. The method according to claim 32, further comprising:
registering an interest in said service by a number of communication devices; and
identifying the communication devices that have registered an interest in said service and that are located in the at least one of the current location of, and the location to be visited by, the mobile service provider, such that said wireless message is transmitted to said communication devices.

35. The method according to claim 34, wherein registering an interest in said service by said number of communication devices is specific to at least one of a particular geographic location and a location identified by a postcode.

36. The method according to claim 32, wherein said wireless message includes contact details for said mobile service provider, the method further comprising:
receiving said wireless message at a number of communication devices; and
contacting, by one or more users of said communication devices, said mobile service provider in response to receiving said wireless message.

37. The method according to claim 32, further comprising:
broadcasting, by said intermediate device, a message to said number of communication units within a location area indicating an availability of said mobile service provider.

38. The method according to claim 34, further comprising:
accessing a database, by said intermediate server, to identify a group of users that have registered an interest in said service provided by said mobile service provider.

39. The method according to claim 38, wherein said database contains location information for a number of said users such that one or more of said user are informed by said serving intermediate device when said mobile service provider enters at least one of a communication cell, a geographic area, and a post code area matching said location.

40. The method according to claim 34, wherein registering an interest in said service comprises:
subscribing, by a user interested in said service provided by said mobile service provider, to at least one of a network operator and a wireless service provider operating said serving intermediate device, such that information relating to said service is communicated to said subscribed user.

41. The method according to claim 32, further comprising:
accessing a database, by said mobile service provider, wherein said database identifies a group of users in a location that have registered an interest in said service provided by said mobile service provider;
downloading a list of said group of users;
moving into said location by said mobile service provider; and
transmitting a wireless message to a number of said group of users directly by said mobile service provider based on said downloaded list.

42. The method according to claim 32, the method further comprising:
polling a number of communication devices in at least one of the same geographic area and cell where said mobile service provider is located to determine whether any of said polled communication devices have registered an interest to use a service offered by said mobile service provider.

43. The method according to claim 32, further comprising:
notifying said number of communication devices in a location of at least one of an event and an availability of said service at said location, via a short message service (SMS) message.

44. The method according to claim 32, wherein the transmission of a wireless message to a number of communication devices is sent at least one of:
(i) intermittently,
(ii) periodically, and
(iii) during low traffic periods to utilize less expensive calling rates.

45. The method according to claim 37, wherein broadcasting a message of said availability of said mobile service provider (112) is sent at least one of:
(i) intermittently,
(ii) periodically, and
(iii) during low traffic periods to utilize less expensive calling rates.

46. The method according to claim 37, wherein the transmission of a wireless message is sent on the same wireless communication system, as said step of broadcasting a message of said availability.

47. The method according to claim 37, wherein broadcasting a message of said availability is sent on an adjunct communication system to the communication system facilitating the transmission of a wireless message.

48. The method according to claim 37, wherein at least one of said intermediate device, and a device operably coupled thereto, authenticates said mobile service provider prior to broadcasting said service of said mobile service provider.

49. The method according to claim 32, wherein providing location based services by a mobile service provider using a wireless communication system that facilitates communication is implemented at least in part using a storage medium storing processor-implementable instructions adapted to control a processor.

50. The method according to claim 32, wherein the wireless communication system is one of a UMTS communication system, a GSM communication system, a GPRS communication system, and a Bluetooth communication system.

51. The method according to claim 32, wherein the mobile communication unit of the mobile service provider is one of: a cellular phone, a portable radio, a mobile radio, a personal digital assistant, a laptop computer, and a wirelessly networked PC.

52. A mobile communication unit for use by a mobile service provider, comprising:
a processor; and
a transmitter, operably coupled to and responsive to said processor, wherein said processor is configured to provide location information of at least one of a current location of, and a location to be visited by, the mobile service provider to initiate transmission of a wireless message to a number of communication devices in a location, where the location corresponds to the at least one of the current location of, and the location to be visited by, the mobile service provider, and wherein said wireless message indicates a service to be provided by said mobile service provider in said location.

53. The mobile communication unit according to claim 52, wherein said mobile communication unit is adapted to function as a mobile service provider advertising device and said wireless message includes one or more of the following: mobile service provider contact details, a service provided/offered by a user of the mobile communication unit, a communication cell or geographical location of, or to be visited by, the mobile communication unit.

54. The mobile communication unit according to claim 52, the mobile communication unit further comprising a receiver and a memory unit, operably coupled to said processor, said receiver arranged to receive a list of subscriber groups that have registered an interest in the service offered by the mobile service provider in a particular geographic area or communication cell, and said memory unit is configured to store said received list.

55. The communication unit according to any of claim 52, wherein the communication unit is one of: a cellular phone, a portable radio, a mobile radio, a personal digital assistant, a laptop computer, and a wirelessly networked PC.
